(19) United States
(12) Patent Application Publication
(10) Pub. No.: US 2025/0102817 A1
(43) Pub. Date: Mar. 27, 2025

(54) ELECTRONIC DEVICE WITH BUMPER

(71) Applicant: Apple Inc., Cupertino, CA (US)

(72) Inventors: John Cagle, San Jose, CA (US); Adam Y. Kollgaard, San Jose, CA (US); Shannon Pomeroy, San Francisco, CA (US); Paul X. Wang, Cupertino, CA (US)

(21) Appl. No.: 18/826,352

(22) Filed: Sep. 6, 2024

Related U.S. Application Data
(60) Provisional application No. 63/585,564, filed on Sep. 26, 2023.

(51) Int. Cl. G02B 27/01

(52) U.S. Cl. CPC G02B 27/0176

(57) ABSTRACT

A head-mountable device can include a display frame, an optical component disposed within the display frame, a facial interface, and a rigid bumper connected to the display frame. The rigid bumper can be positioned between the display frame and the facial interface and can further define a gap between the optical component and the facial interface. The facial interface can also include a cushion layer that can be rated for applied loads in a first force range. Furthermore, a stop can be connected to the head-mountable display, wherein the stop can be rated for applied loads within a second force range that is higher than the first force range. The facial interface can further include a front surface facing toward the head-mountable display and a rear surface that can contact a face. A set of structural posts can also be attached to the head-mountable display and positioned adjacent to a forehead region and a maxilla region of a face, wherein a portion of each structural post of the set of structural posts can be embedded in the facial interface.

### CROSS-REFERENCE TO RELATED APPLICATION

This application claims the benefit of U.S. Provisional Patent Application No. 63/585,564, filed 26 Sep. 2023, and entitled “ELECTRONIC DEVICE WITH BUMPER,” the entire disclosure of which is hereby incorporated by reference.

### FIELD

The described embodiments relate generally to electronic devices. More particularly, the present embodiments relate to structural posts or bumpers of a head-mountable device.

### BACKGROUND

Recent advances in portable computing have enabled head-mountable devices (HMD) that provide augmented and virtual reality (AR/VR) experience to users. These HMDs have many components, such as a display, viewing frame, lens, batteries, and other components. Certain components of the HMD can also help create a unique user experience. HMDs typically include a display and a set of optical components, which can enable a user to view and interact with visualizations presented through the components of the HMD.

These and other components of an HMD can include components that are sensitive to stresses and strain (e.g., from applied forces or force distribution). Additionally or alternatively, some components can be positionally fixed in place and should not be moved. Therefore, there is a constant need for HMDs with more structural integrity that can help protect certain components, while also maintaining (or at least not detracting from) user comfort.

### SUMMARY

Various examples of the present disclosure, an apparatus includes a display frame, an optical component disposed within the display frame, a facial interface, and a rigid bumper. The rigid bumper can be connected to the display frame and positioned between the display frame and the facial interface, where the rigid bumper can further define a fixed gap between the optical component and the facial interface.

In at least one example, the facial interface can include a compressible portion, where the compressible portion can be compressed until it is hard-stopped by the rigid bumper. In some examples, the rigid bumper can include a force-rating in excess of 20 Newtons. In another example, the force-rating of the rigid bumper can exceed 1000 Newtons.

In some examples, the rigid bumper can be constructed out of an aluminum material, a fiber-reinforced plastic material, or an engineering plastic material. The rigid bumper can also be positionally fixed relative to the display frame and the facial interface. In some examples, the rigid bumper can include a portion embedded within the facial interface, wherein the portion of the rigid bumper embedded within the facial interface can be obscured from an exterior view of the facial interface.

In various examples of the present disclosure, the facial interface can include a front surface that is opposite a rear surface, wherein the rear surface can also be a skin-facing surface. The rigid bumper can also include an end surface that can be attached to the front surface of the facial interface.

In at least one example, the facial interface can include a cushion layer with a front surface facing toward the head-mountable display. In some examples, the cushion layer can be rated for applied loads within a first force range. A stop can also be connected to the head-mountable display and the front surface, where the stop can be rated for applied loads within a second force range that is higher than the first force range. In at least one example, an end surface of the stop can be connected to the front surface of the facial interface such that a full length of the stop can be positioned in series with the facial interface.

In some examples of the present disclosure, the cushion layer can include an amount of travel configured to bottom out against the stop at an end of the first force range. Furthermore, at the end of the first force range, the stop can be configured to begin providing a normal force against an applied load. In at least one example, the stop can also be removable.

In various examples, the facial interface can have a front surface facing toward the head-mountable display and a rear surface to contact a face. A set of structural posts can also be attached to the head-mountable display and positionable adjacent to a forehead region and a maxilla region of a face. In some examples, a portion of each structural post of the set of structural posts can be embedded in the facial interface.

In another example of the present disclosure, an energy dissipation layer can be positioned forward of the front surface of the facial interface. In this example, a portion of each structural post of the set of structural posts can also be embedded in the energy dissipation layer.

In at least one example, an end portion of each structural post of the set of structural posts is positioned forward of the rear surface of the facial interface. In another example, the end portions of each structural post of the set of structural posts can be positioned approximately flush with the rear surface of the facial interface. Furthermore, in at least one example, the end portion of each structural post can include a cover flap, where the cover flap can include a foam flap or a textile flap.

### BRIEF DESCRIPTION OF THE DRAWINGS

The disclosure will be readily understood by the following detailed description in conjunction with the accompanying drawings, wherein like reference numerals designate like structural elements, and in which:

FIG. 1A shows a top profile view of an example head-mountable device including an example rigid bumper.

FIG. 1B shows a side profile view of an example head-mountable device including an example rigid bumper.

FIG. 1C shows a top profile view of an example head-mountable device including an example rigid bumper.

FIG. 2A shows a force-deflection graph for a portion of an example head-mountable device.

FIG. 2B shows another force-deflection graph for a portion of another example head-mountable device.

FIGS. 3A-3B show an example location of a rigid bumper implemented in series with a facial interface.

FIGS. 4A-4C show another example location of a rigid bumper implemented at least partially in parallel with a facial interface.

FIGS. 5A-5B show another example implementation of a rigid bumper.

FIG. 6 shows yet another example implementation of a rigid bumper together with an energy dissipation layer.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The following disclosure relates generally to electronic devices, specifically a head-mountable electronic device (or head-mountable device). In at least one example, a head-mountable device can include a viewing frame and a securement arm (or strap/band) extending from the viewing frame. Examples of head-mountable electronic devices can include virtual reality or augmented reality devices that include an optical component. In the case of augmented reality devices, optical eyeglasses or frames can be worn on the head of a user such that optical windows, which can include transparent windows, lenses, or displays, can be positioned in front of the user's eyes. In another example, a virtual reality device can be worn on the head of a user such that a display screen is positioned in front of the user's eyes. The viewing frame can include a housing (e.g., a display housing or display frame) or other structural components supporting the optical components, for example lenses or display windows, or various electronic components.

Additionally, a head-mountable electronic device can include one or more electronic components used to operate the head-mountable electronic device. These components can include any components used by the head-mountable electronic device to produce a virtual or augmented reality experience. For example, electronic components can include one or more projectors, waveguides, speakers, processors, batteries, circuitry components including wires and circuit boards, or any other electronic components used in the head-mountable device to deliver augmented or virtual reality visuals, sounds, and other outputs. The various electronic components can be disposed within the electronic component housing. In some examples, the various electronic components can be disposed within, or attached to, one or more of the display frame, the electronic component housing, or the securement arm.

More particularly, the present disclosure relates to rigid bumpers of a head-mountable electronic device (or head-mountable device). For example, a rigid bumper as disclosed herein relates to force-distribution elements or structural posts for head-mountable devices that can serve as a protective roll cage or fixed offset for sensitive components (e.g., optical components) disposed within the a head-mountable device (hereafter “HMD”). In some examples, the rigid bumpers of the present disclosure can also establish a comfort zone in which more pliant elements (such as a facial interface discussed below) can flexibly move and adjust. In particular examples, the rigid bumpers of the present disclosure are indeed separate from (or discrete elements relative to) the pliant, comfort element(s) of an HMD.

In at least one example, a head-mountable device can include a display frame, with an optical component disposed within the display frame, and a facial interface. A rigid bumper can be connected to the display frame and positioned between the display frame and the facial interface, wherein the rigid bumper can also define a fixed gap between the optical component and the facial interface. The fixed gap between the optical component and the facial interface can help maintain structural or component integrity of the optical component. For instance, the rigid bumper and fixed gap can prevent the facial interface from flexing into and damaging the optical component. In at least one example, the configuration of the rigid bumper (or arrangement of multiple rigid bumpers) and the facial interface can enable the head-mountable device to distribute applied forces exerted on the head-mountable device.

Current wearable devices are not typically suited for (or rated for) a wide range of applied forces directed toward various regions of the head-mountable device and/or a user's head. Accordingly, conventional wearable devices (e.g., HMDs) are ill-equipped to safeguard sensitive components and maintain user comfort. In contrast, the various examples of a rigid bumper described herein are designed for user comfort and overall structural integrity of the device. Any component of the disclosed device, including the facial interface, rigid bumpers, energy dissipation layers, and other components mentioned herein, can be designed and placed strategically to maintain the overall comfort of the user and/or the structural integrity of the device.

In a particular example, the facial interface can include a compressible portion, wherein the compressible portion can be compressed until hardstopped by the rigid bumper. In some examples, the compression of the compressible portion can be rated for applied loads within a first force range. Furthermore, the rigid bumper can be rated for applied loads within a second force range that is higher than the first force range. This can allow the head-mountable device to withstand and dissipate a wide range of applied loads while providing comfort for the user and retaining overall structural integrity of the device.

In another example of the present disclosure, the rigid bumper can be positionally fixed relative to the display frame and the facial interface. In a particular example, the rigid bumper can be positioned between the facial interface and the display frame, wherein the full length of the rigid bumper can be placed in series with the facial interface. This can enable the facial interface to fully compress before being hardstopped by the rigid bumper when a force is applied to the device.

In at least one example, a portion of the rigid bumper can be embedded in the facial interface. In some examples of the present disclosure, a rigid bumper can be positioned approximately flush with the rear surface of the facial interface. This can enable the facial interface and the rigid bumper to work simultaneously (e.g., in tandem or in parallel) to distribute forces exerted on the device, thereby providing structural integrity and user comfort.

In at least one example, a head-mountable device can further include an energy dissipation layer that can be positioned forward of the front surface of the facial interface (where the rear surface of the facial interface can include a skin-facing surface to contact a user's face). In this example, a portion of the rigid bumper can also be embedded in the energy dissipation layer, thus enabling the head-mountable device to further distribute forces and maintain structural integrity throughout the body of the device.

An HMD of the present disclosure can include multiple rigid bumpers that are positioned at specific locations. For example, a head-mountable device can include a set of rigid bumpers, wherein the set of rigid bumpers can be attached to the head-mountable display and positionable adjacent to a forehead region and a maxilla region of a face. Other example bumper locations (e.g., a zygoma region) are also herein contemplated. This can enable the head-mountable device to better distribute an applied load over a greater surface area, therefore increasing user comfort during device operation.

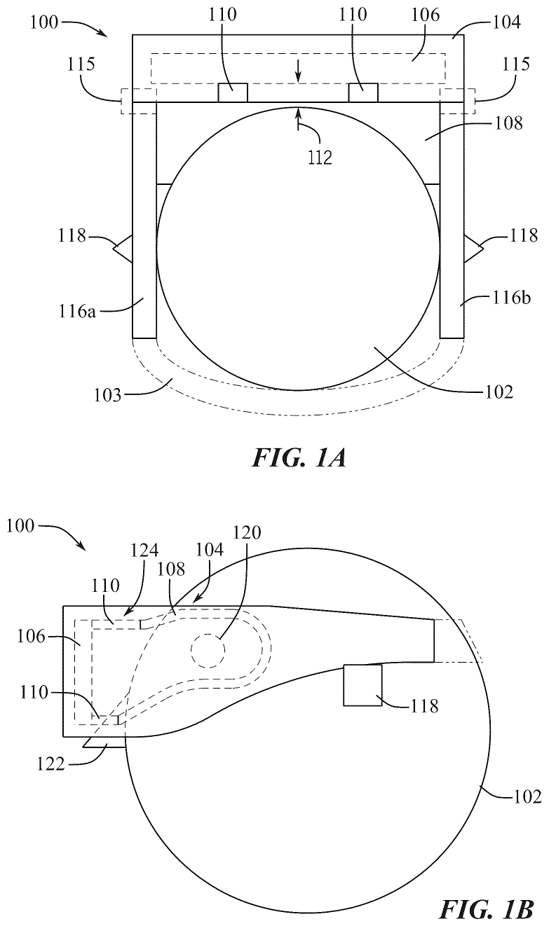

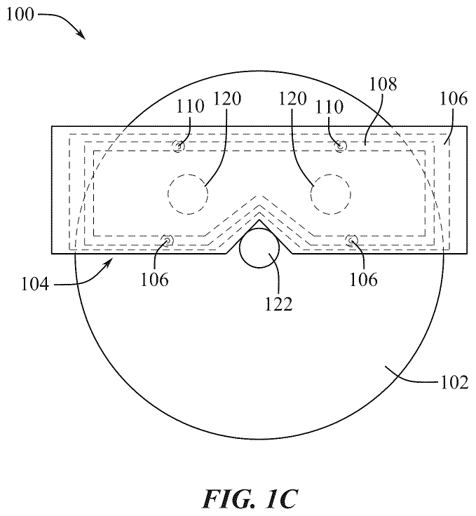

These and other embodiments are discussed below with reference to FIGS. 1-6. However, those skilled in the art will readily appreciate that the detailed description given herein with respect to these Figures is for explanatory purposes only and should not be construed as limiting. Furthermore, as used herein, a system, a method, an article, a component, a feature, or a sub-feature comprising at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1 illustrates a top profile view of a head-mountable device 100 worn on a user's head 102 in accordance with one or more examples of the present disclosure. While the present systems and methods are described in the context of a head-mountable device 100, the systems and methods can be used with any wearable apparatus, or any apparatus or system that can be physically attached to a user's body, but are particularly relevant to an electronic device worn on a user's head 102. The head-mountable device 100 can include a display frame 104, wherein the display frame 104 can be configured to house various components. As used herein, the terms “display frame,” “frame,” and “housing” can refer to a portion of a head-mountable device that contains a display or display window. As used herein, the term “display” or “display window” can refer to a lens, a cover glass, or another surface designed to display a projected image on a somewhat transparent surface, or any other component that presents visual media or information to a user.

In at least one example, an optical component 106 can be disposed in the display frame 104. In some examples, the optical component 106 can include one or more optical lenses or display screens set in front of the eyes of the user. The optical component 106 can also include a display, wherein the display can be used for presenting augmented reality visualizations, a virtual reality visualization, or other suitable visualization to the user.

In at least one example, the head-mountable device 100 can include a facial interface 108, wherein the facial interface 108 can be a portion of the head-mountable device 100 that can engage a user's face via direct contact. In some examples, the facial interface 108 can be constructed with various materials, such that the facial interface 108 can be enabled to conform or compress directly to the face of a user. The ability of the facial interface 108 to conform to the face of the user can be advantageous in that it can provide a comfortable experience to a wide range of different users, accommodating varying head and face shapes. The ability of the facial interface 108 to compress can also be advantageous in that forces applied to the head-mountable device 100 can be lessened and distributed across a user's head 102. In the event that an applied force is exerted on the head-mountable device 100, the facial interface 108 can compress and absorb a portion of the applied force, thus creating a more comfortable experience for the user.

Additionally, in some examples, the facial interface 108 can include various components forming a structure, webbing, cover, fabric, or frame of a head-mountable device 100 disposed between the optical component 106 and the user's head 102. In at least one example, the facial interface 108 can include a seal (e.g., a light seal, environment seal, dust seal, air seal, etc.). The term “seal” can include partial seals or inhibitors, in addition to complete seals, e.g., a partial facial interface where some ambient light is blocked and a complete facial interface where all ambient light is blocked when the head-mountable device 100 is donned.

In some examples, the facial interface 108 can be attached to or positioned adjacent to a rigid bumper 110. As used herein, the terms “rigid bumper,” “stop,” or “structural post” can be used interchangeably to refer to a support, backstop, bulwark, absorber, buffer, column, or block. In these or other examples, a rigid bumper can be positionally fixed relative to other components of the head-mountable device 100. In particular, a rigid bumper can comprise a stiff, rigid, or hardened material (e.g., for resisting impact forces or bending moments, transferring applied loads, or providing a fixed datum). In certain examples, a rigid bumper includes a metal material (e.g., aluminum), an engineering plastic material, a fiber reinforced plastic material, etc. Thus, in particular examples, the rigid bumper 110 can be a kind of structural post that can extend from the display frame 104. The rigid bumper 110 can also abut and/or be at least partially embedded within the facial interface 108 (as will be discussed below). In at least one example, the facial interface 108 can be removed from the head-mountable device 100 by use of a button, snap, or other detachment method.

The rigid bumper 110 can be positionally arranged in various ways. For example, the rigid bumper 110 can be connected to the display frame 104 and disposed between the display frame 104 and the facial interface 108, wherein the forward end of the rigid bumper 110 can be attached to the rear end of the display frame 104, and the rear end of the rigid bumper 110 can be attached to the forward end of the facial interface 108. In at least one example, the rigid bumper 110 can define a fixed gap 112 between the optical component 106 and the facial interface 108.

In some examples, the rigid bumper 110 can be attached to the display frame 104 by the use of a fastener 114. Examples of a fastener can include a screw, clamp, lock, or any other fastening device. The use of a fastener 114 can enable the user to remove or detach the rigid bumper 110. This can allow the user to gain access to other components disposed within the head-mountable device 100 or else swap the rigid bumper 110 for a different size and/or shape of bumper. Additionally or alternatively, the rigid bumper 110 can be positionally adjusted for different force mappings (e.g., force distributions per a finite element analysis), different facial profiles, and/or for user comfort. In alternative implementations, the rigid bumper 110 is permanently affixed in place and cannot be removed without specific tools and access.

Additionally shown in FIG. 1, the head-mountable device 100 includes one or more arms 108, 110. The arms 116a, 116b are connected to the display frame 104 and extend distally toward the rear of the head 102. The arms 116a, 116b are configured to secure the display frame 104 in a position relative to the user head 102 (e.g., such that the display frame 104 is maintained in front of a user's eyes 120). For example, the arms 116a, 116b extend over the user's ears 118. In certain examples, the arms 116a, 116b rest on the user's ears 118 to secure the head-mountable device 100 via friction between the arms 116a, 116b and the user head 102. For example, the arms 116a, 116b can apply opposing pressures to the sides of the user head 102 to secure the head-mountable device 100 to the user head 102. Optionally, the arms 116a, 116b can be connected to each other via a strap 103 (shown in the dashed lines) that can compress the head-mountable device 100 against the user head 102. In particular examples, the strap 103 is connected to at least the frame of the display frame 104 or the facial interface 108.

In specific examples, the arms 116a, 116b are connected to the display frame 104 via a pivot joint 115. The pivot joint 115 can be external or internal with respect to the arms 116a, 116b and/or the display frame 104. In these or other examples, the pivot joint 115 can allow the display frame 104 to rotate about the pivot joint 115 independent of the arms 116a, 116b. To do so, the pivot joint 115 can include a detent hinge, a friction hinge, a passive hinge, a full lock-out hinge, etc.

FIG. 1B illustrates a side view of the head-mountable device 100. In at least one example, the facial interface 108 can extend around the face of the user. In some examples, the facial interface 108 can extend back behind a user's eyes 120 and down to a user's nose 122. This can enable the facial interface 108 to make extended contact with a user's head 102. Furthermore, in at least one example, the facial interface 108 can be configured to contact the user's head in other places, such as the maxilla, lateral forehead, central forehead, and zygomatic regions of the user's head 102. This can be advantageous to the user in that the head-mountable device 100 can better conform to a user's head 102. In some examples, an applied force can be exerted on the head-mountable device 100. In this case, the facial interface 108 can further compress to a user's head 102 to lessen the forces felt by the user and/or provide a desired fit. An extended contact of the facial interface 108 around a user's eyes 120 and on a user's nose 122 can also be advantageous in that it can distribute the compression across a greater surface area, thus further decreasing the applied forces felt by the user.

In at least one example, the rigid bumper 110 can extend from the optical component 106 towards the user's head 102. A stiffness of the rigid bumper 110 can help protect or maintain the structural integrity of the optical component 106. To illustrate, in some examples, the rigid bumper 110 can be made out of a material having a stiffness range that can withstand different applied forces and/or impart a particular force-rating for the head-mountable device 100. In some examples, the stiffness range is approximately 100 N/mm to approximately 2500 N/mm, approximately 250 N/mm to approximately 1500 N/mm, or approximately 500 N/mm to approximately 1000 N/mm. This stiffness range can further add to the structural integrity of the head-mountable device 100 in that the rigid bumper 110 can be in a fixed position relative to the display frame 104.

In these or other examples, the term “force-rating” refers to a level, number, degree, range, value, binary, or grade that corresponds to a component's ability to withstand an applied force (or in certain cases, a predetermined force, a standard force, or a range of forces). In some examples, a force-rating indicates a component's ability to elastically deform without plastic (or permanent) deformation in response to an applied force. In certain examples, a force-rating indicates a component's ability to plastically deform within a predetermined range of deformation (e.g., an acceptable range of strain or deflection) in response to an applied force. Similarly, in some examples, a force-rating can refer to an engineering standard, a testing standard, etc. To illustrate a few examples, the rigid bumper 110 can include a force-rating in excess of 20 Newtons. In particular implementations, the rigid bumper 110 can include a force-rating that exceeds 1000 Newtons. Likewise, in some implementations, the rigid bumper 110 can include a force-rating that satisfies one or more requirements of Augmented, Virtual and Mixed Reality Testing Certification Standard UL8400.

In certain examples, manufacturing methods can be implemented to impart specific material properties, including stiffness, to the rigid bumper 110. Some examples include cold rolling, annealing, precipitation hardening, case hardening, flame hardening, quenching, and tempering. In at least one example, the rigid bumper 110 can also be covered with a coating 124, wherein the coating 124 can add to the stiffness of the rigid bumper 110. Additionally or alternatively, the rigid bumper 110 can include a structural design (e.g., a lattice structure, a honeycomb structure, a custom machined structure, a cored-out structure, etc.) that can reduce weight and/or impart material properties, including directional properties for desired anisotropy.

FIG. 1C shows a front view of the head-mountable device 100. As shown in FIG. 1C, the rigid bumpers 110 can be a set of structural posts attached to the display frame 104. The rigid bumpers 110 can be adjacent to different regions of the user's head 102. In some examples, the rigid bumpers 110 can be positioned adjacent to different regions of a user's head 102. For example, rigid bumpers 110 can be placed adjacent to the maxilla, lateral/central forehead, and zygomatic regions of a user's head 102.

As used herein, the term “forehead region” refers to an area of a human face between the eyes and the scalp of a human. Additionally, the term “zygoma region” refers to an area of a human face corresponding to the zygomatic bone structure of a human. Similarly, the term “maxilla region” refers to an area of a human face corresponding to the maxilla bone structure of a human.

The relative positioning of the rigid bumper 110 to specific areas of the user's head 102 can comfortably distribute applied loads around a user's head 102. This can be advantageous in that rigid bumpers 110 positioned adjacent to different regions of a user's head 102 can enable the head-mountable device 100 to retain structural integrity when applied forces are exerted on the head-mountable device 100 from various angles, therefore providing added comfort to the user in a variety of situations.

Furthermore, the head-mountable device 100 can include a profile geometry with a section-based reaction to an applied force. In at least one example, the head-mountable device 100 can react to an applied force in sections. For example, the sections of the head-mountable device 100 can be separated into at least a maxilla section, a lateral forehead section, and a central forehead section. In some examples, these different sections can be optimized for reactions to the surface and skin shapes of a user's head as well as for the bone-shape of these sections. The different sections of the head-mountable device 100 can be configured to conform to the bone-structure of a user's face in a particular section. For example, the maxilla section can be configured to conform to a maxilla bone-structure in a reaction to an applied force.

Additionally, in some examples, the different sections of the head-mountable device 100 described above can be configured to react in a set order. In some examples, the order in which the sections react can be tuned to create a different series of contacts. This can be advantageous in that different series of contacts can help distribute an applied force with respect to the type of applied force and location where the force in applied. For example, a force applied to the maxilla section of the head-mountable device 100 can react with a particular series of contacts that help distribute the applied force to other sections of the head-mountable device 100.

In at least one example, the head-mountable device 100 can also include an optical housing or module that carries optical components (e.g., sensors, light emitting diodes, cameras, etc.). In these or other examples, the rigid bumper 110 can include a fixed datum relative to the optical module. In specific instances, the rigid bumper 110 can include a particular radii that dictates a fixed offset relative to the optical module (e.g., to help ensure the rigid bumper 110 itself is not pushed into an optical component). In some examples, the optical section can have radii of about 0.1 mm to about 10 mm, about 0.5 mm to about 5 mm, or about 1 mm to about 1.5 mm.

Any of the features, components, and/or parts, including the arrangements and configurations thereof shown in FIGS. 1A through 1C can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 1A through 1C. The following description discusses force-deflection curves that graphically depict how example implementations of a facial interface and a rigid bumper react to an applied force.

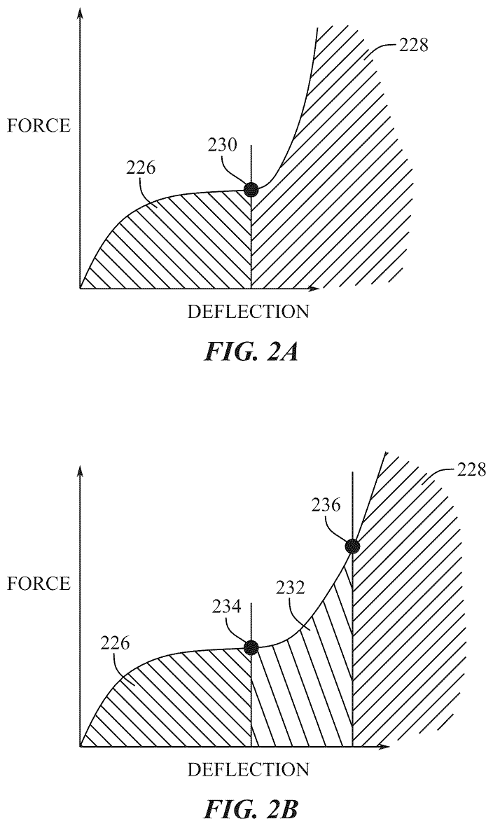

FIGS. 2A and 2B illustrate force-deflection graphs for a head-mountable device according to one or more examples of the present disclosure. In at least one example, when a force is exerted on the head-mountable device 100, different components of the head-mountable device 100 can be engaged to absorb and distribute applied forces (and/or prevent component flexure into sensitive optical components). In at least one example, these components can include, but are not limited to, the facial interface 108, the rigid bumper 110, or a combination of both facial interface 108 and rigid bumper 110 of the head-mountable device 100. In the event of an applied force exerted on the device, the force felt by the user can be less than the one exerted on the device, thus creating a more comfortable experience for the user while operating the head-mountable device 100.

As the power of an applied force increases, different combinations of the components disposed in the head-mountable device 100 can be utilized to deflect a range of such forces. For example, FIG. 2A illustrates a graph where there can be a first force range 226 and a second force range 228 of force-deflection. The first force range 226 can include the force-deflection relationship of lower applied forces that can be deflected by the facial interface 108. In some examples, low applied forces exerted on the head-mountable device 100 shown in the first force range 226 can be mostly or fully absorbed by the compression of the facial interface 108. In at least one example, the first force range 226 can include exerted forces from 0 Newtons (N) up to a force threshold 230. The force threshold 230 can range from about 2 N to about 1000 N, about 5 N to about 700 N, about 10 N to about 100 N, or about 12 N to about 20 N.

In some examples, when a greater applied force is exerted on the head-mountable device 100, the applied force can exceed the force threshold 230. In these examples, the facial interface 108 may not be able to fully absorb the forces exerted on the head-mountable device 100. In some examples, the head-mountable device 100 can combine the absorption/deflection capabilities of both the facial interface 108 and the rigid bumper 110, therefore increasing the amount of force that can be distributed across the head-mountable device 100. Thus, applied forces in excess of the threshold 230 can be absorbed by a combination of the facial interface 108 and the rigid bumper 110. For example, when an applied force causes the facial interface 108 to compress (and in some cases, locally bottom out or fully compress), the rigid bumper 110 can handle the higher force loads that the facial interface 108 does not.

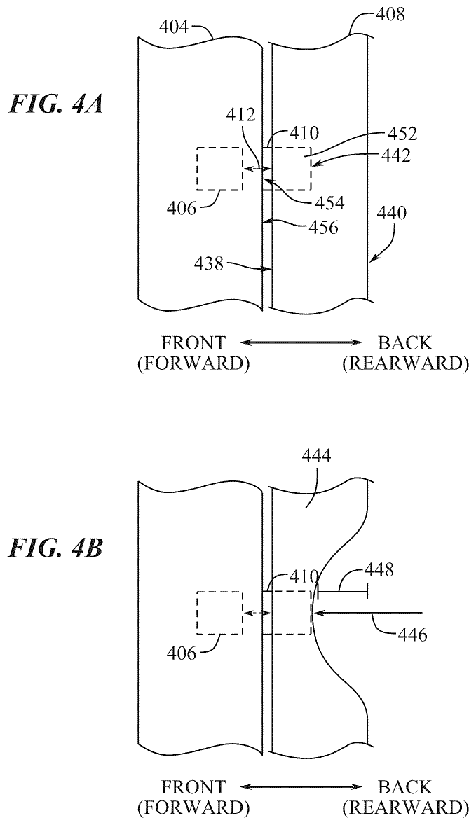

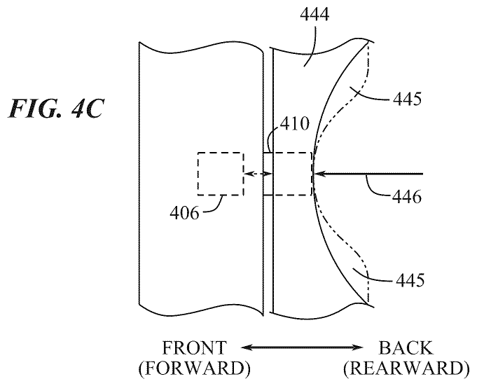

In at least one example, the second force range 228 can include the force-deflection relationship of higher applied forces that can be absorbed by the rigid bumper 110. In some examples, higher applied forces exerted on the head-mountable device 100 shown in the second force range 228 can be mostly or fully absorbed by the stiffness of the rigid bumper 110, wherein the rigid bumper 110 can exert a normal force in opposition to an applied force. In at least one example, the second force range 228 can include applied forces from the threshold 230 up to forces exceeding 5000 N, between the threshold 230 up to about 3000 N, or between the threshold 230 up to about 1500 N. However, in certain implementations (such as the “parallel” implementations discussed below in relation to FIGS. 4A-6), the rigid bumper can also provide normal forces or other structural support at loads below the threshold 230. Further, in some implementations, the force-deflection curve can include a gap between the first force range 226 and the second force range 228 (e.g., such that the threshold 230 can include a range of forces beyond the capability of facial interface 108, but too low to cause any deflection in the rigid bumper 110).

FIG. 2B illustrates another force-deflection graph for a head-mountable device according to one or more examples of the present disclosure. In one example, the force-deflection graph can be split into a first force range 226, a second force range 228, and a third force range 232, wherein the third force range 232 can separate the first two zones. The first force range 226 can include the force-deflection relationship of lower applied forces that can be absorbed by the facial interface 108, and the second force range 228 can include the force-deflection relationship of higher applied forces that can be absorbed by the rigid bumper 110. In some examples, a low force threshold 234 can separate the first force range 226 from the third force range 232, wherein the third force range 232 can include the force-deflection relationship of forces that can be absorbed by a combination of both the facial interface 108 and the rigid bumper 110. In one example, a high force threshold 236 can separate the third force range 232 from the second force range 228.

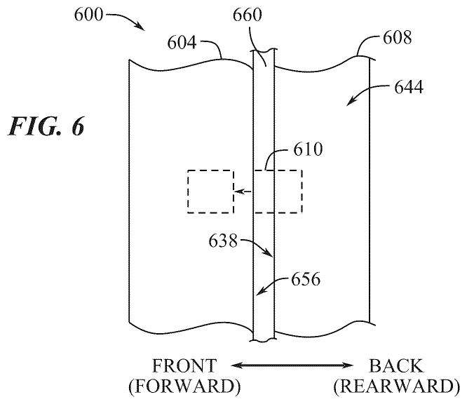

In another example, the third force range 232 illustrated in FIG. 2B can include forces deflected by an energy dissipation layer 660, as shown in FIG. 6. In this example, the addition of an energy dissipation layer 660 can enable the head-mountable device 100 to deflect a greater amount of applied forces without moving into the second force range 228. This can be advantageous to the head-mountable device 100 in that more energy can be absorbed/deflected before the size of the applied force crosses the high force threshold 236, therefore increasing the structural integrity of the head-mountable device and/or the comfort of the user when faced with larger forces applied to the device.

Any of the features, components, and/or parts, including the arrangements and configurations thereof shown in FIGS. 2A and 2B can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 2A and 2B.

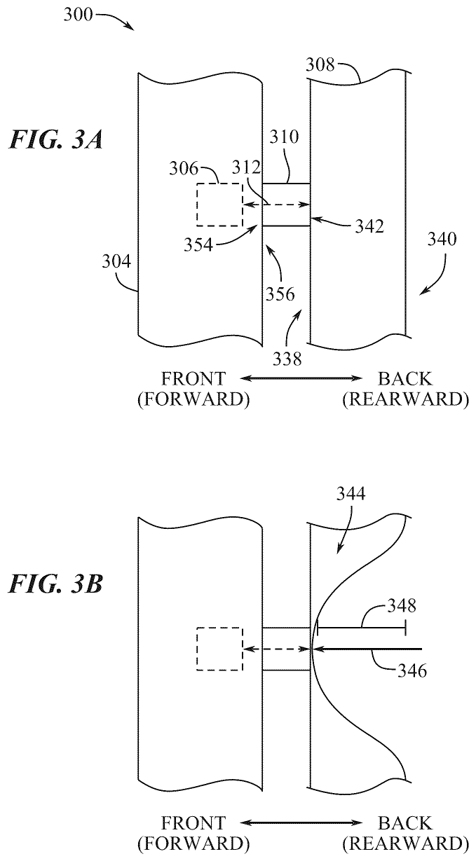

The following description discusses the interplay between a facial interface and a rigid bumper that is arranged in a “series” (e.g., back-to-back) interface-bumper configuration. In accordance with one or more examples of the present disclosure, FIGS. 3A and 3B illustrate an example location of a rigid bumper. In at least one example, the rigid bumper 310 can be positionally fixed relative to the display frame 304 and the facial interface 308, wherein the rigid bumper 310 is positioned between the display frame 304 and the facial interface 308. In this example, the display frame 304, the rigid bumper 310, and the facial interface 308 can be configured in series with each other. This can be advantageous to the user in that the series configuration can isolate the different components of the head-mountable device 300 in that they can work independently to dissipate a force exerted on the head-mountable device 300.

In at least one example, the facial interface 308 can include a front surface 338, wherein the front surface 338 can be opposite a rear surface 340. The rear surface 340 of the facial interface 308 can be configured to contact the user's skin. In some examples, the rigid bumper 310 can include an end surface 342 that can attach to the front surface 338 of the facial interface 308, wherein the full length of the rigid bumper 310 can be positioned in forward of the facial interface 308. Furthermore, the front end 354 of the rigid bumper 310 can be attached to the rear side 356 of the display frame 304, where the full length of the rigid bumper 310 can be disposed between the display frame 304 and the facial interface 308. This configuration can enable the display frame 304, the rigid bumper 310, and the facial interface 308 to be in series with each other.

In at least one example, the positioning of the rigid bumper 310 can create a gap 312 between the facial interface 308 and the optical component 306. This gap 312 can be defined as a void, distance, or overall separation between the optical component 306 and the facial interface 308. This gap 312 can be advantageous in that it can keep a fixed distance between the facial interface 308 and the optical component 306, therefore the optical component 306 can be kept at a distance desirable from for user to comfortably operate the head-mountable device 300.

FIG. 3B shows an example of components disposed in the head-mountable device 300 configured in series with each other where an applied load 346 is exerted on the head-mountable device 300. An applied load 346 can include any external or internal force that is exerted on the head-mountable device 300. For example, an external object pressed against the head-mountable device 300 can be an external force, whereas the action of retaining the head-mountable device 300 on a user's head 102 can be an example of an internal applied load 346. In at least one example, the facial interface 308 can include a cushion layer 344. In some examples, the cushion layer 344 forms the entirety of the facial interface 308. In other examples, the cushion layer 344 includes a discrete layer with specific material properties distinct from other portions of the facial interface 308. In certain examples, the cushion layer 344 is a foam layer.

In these or other examples, the cushion layer 344 can be a compressible portion of the facial interface 308. In some examples, the cushion layer 344 can compress until it is hardstopped by the rigid bumper 310, as shown in FIG. 3B. In some examples, the cushion layer 344 of the facial interface 308 can be rated an applied load 346 within a first force range 226, as illustrated in FIG. 2A. Furthermore, in some examples the cushion layer 344 can include a travel length 348. The travel length 348 can be a distance the cushion layer 344 can compress when a load is applied to the head-mountable device 300. In some examples, the cushion layer 344 can be configured to bottom out against the rigid bumper 310 at the end of the first force range 226. The cushion layer 344 and the associated travel length 348 can enable the head-mountable device 300 to distribute an applied load 346 without putting significant pressure on the user's head 102, therefore creating a more comfortable operating experience for a user.

In some examples, the rigid bumper 310 can be attached to the front surface 338 of the facial interface 308, wherein the rigid bumper 310 can be rated for applied loads 346 within a second force range 228 that is higher than the first force range 226, as illustrated in FIG. 2A. According to some examples, when an applied load 346 to the head-mountable device 300 exceeds the first force range 226, the cushion layer 344 can be fully compressed against the rigid bumper 310. As the cushion layer 344 is fully compressed, the rigid bumper 310 can be configured to then provide a normal force against an applied load 346 at the end of the first force range 226. This can be advantageous to the user in that the head-mountable device 300 can be rated for a significantly larger range of applied loads 346 while maintaining comfort for the user and overall structural integrity.

Any of the features, components, and/or parts, including the arrangements and configurations thereof shown in FIGS. 3A and 3B can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 3A and 3B.

The following description discusses the interplay between a facial interface and a rigid bumper that is at least partially embedded in the facial interface, e.g., a “parallel” interface-bumper configuration in contrast to the “series” interface-bumper configuration just discussed in relation to FIGS. 3A-3B. In accordance with one or more examples of the present disclosure, FIGS. 4A through 4C illustrate an additional example position of a rigid bumper disposed in of the head-mountable device 400. In at least one example, the head-mountable device 400 can include a facial interface 408. The facial interface 408 can include a front surface 438 and a rear surface 440 opposite the front surface 438, wherein the front surface 438 faces forward and the rear surface 440 faces rearward. In some examples, the rear surface 440 can be configured to contact a user's face.

Additionally, a rigid bumper 410 can be positioned between the display frame 404 and the facial interface 408, wherein the front end 454 of the rigid bumper 410 can be attached to the rear side 456 of the display frame 404. In at least one example, the rigid bumper 410 can also include an embedded portion 452, wherein the embedded portion 452 can be disposed inside the facial interface 408. In at least one example, the embedded portion 452 can be configured to be obscured from an external view of the facial interface 408. In at least one example, the embedded portion 452 can allow part of the facial interface 408 to be positioned forward of the rear surface 442 of the rigid bumper 410. This configuration can position the rigid bumper 410 and the facial interface 408 in parallel with each other. This can be advantageous in that the rigid bumper 410 and the facial interface 408 can work simultaneously to distribute forces across the head-mountable device 400.

In at least one example, a set of rigid bumpers 410 can be attached to the display frame 404. The inclusion of additional rigid bumpers 410 can enable the head-mountable device 400 to retain structural integrity over a greater surface area. Furthermore, the set of rigid bumpers 410 can also include embedded portions 452, wherein the embedded portions 452 can be disposed inside the facial interface 408. This can enable the facial interface 408 to work in parallel with multiple rigid bumpers 410 simultaneously. This can be advantageous to the head-mountable device 400 in that rigid bumpers 410 can apply a normal force in opposition to an applied force for a greater area of the head-mountable device 400. Increased surface coverage for opposition to an applied force can create a more comfortable experience for the user, as a greater amount of force can be distributed across the head-mountable device 400.

In at least one example of the present disclosure, a width (i.e., thickness) of the facial interface 408 can vary across the length of the head-mountable device 400. The width of the facial interface 408 can be a set width, or a different width entirely. For example, the width of the facial interface 408 can increase in areas adjacent to a rigid bumper 410 and decrease in other areas. Different widths of the facial interface 408 can change the travel distance 448 of the cushion layer 444, thus changing the amount of compression in the facial interface. Different widths can be advantageous to users with heads of varying sizes, as some widths of the facial interface 408 can be comfortable for some users and not for others. Varying widths of the facial interface 408 can provide a comfortable operating experience for a wide range of users with different head sizes. Different widths of the facial interface can also enable a tighter or looser fit on a user's head, which can help the head-mountable device 400 sit in a desired position while in operation.

FIG. 4B further illustrates the positioning of certain components when a force is applied to the head-mountable device 400. In this example, the end surface 442 of the embedded portion 452 of the rigid bumper 410 can be disposed forward of the rear surface 440 of the facial interface 408. In the event that an applied load 446 is exerted on the head-mountable device 400, this configuration can enable the cushion layer 444 to have a travel distance 448, wherein the travel distance 448 can include the distance from the rear surface 440 of the facial interface 408 to the end surface 442 of the rigid bumper 410. In this example, when a force is applied to the head-mountable device 400, the cushion layer 444 can compress before the rigid bumper 410 bottoms out. This can enable the head-mountable device 400 to absorb low-energy applied loads 446 without bottoming out on the rigid bumper 410, therefore creating a more comfortable experience for the user.

In some examples, the length of the facial interface 408 can also increase or decrease the size of an applied load 446 that can be absorbed in the first force range. For example, the longer the travel distance 448, the more applied force is required to fully compress the cushion layer 444. Conversely, the shorter the travel distance 448, the less energy an applied load 446 can require to fully compress the cushion layer 444. This can be advantageous to the head-mountable device 400 in that the amount of force that can be absorbed in the first force range 226 can be determined by the length of the facial interface 408.

FIG. 4C illustrates the positioning of certain components when an even greater force is applied to the head-mountable device 400. In this example, an applied load 446 can compress the cushion layer 444 of the facial interface 408. In some examples, the facial interface 408 can compress even further after the rigid bumper 410 has bottomed out. FIG. 4B illustrates the compression of the cushion layer 444 up until the applied force is hard stopped by the rigid bumper 410. FIG. 4C shows further compression of the cushion layer 444 in peripheral zones 445. In at least one example, the peripheral zones 445 can be portions or surfaces of the facial interface 408 not immediately adjacent to the end surface 442 of the rigid bumper 410. Furthermore, the peripheral zones 445 can also be areas of the cushion layer 444 that were partially compressed (i.e., not compressed the entirety of the travel distance 448). This further compression of the peripheral zones 445 can enable the facial interface 408 and the rigid bumper 410 to further operate together to provide a discrete load response to an applied force 446. In this configuration, the rigid bumper 410 can provide a normal force in opposition to the applied load 446 while the facial interface 408 can further compress. This can be advantageous in that the head-mountable device 400 can use both the compression of the facial interface 408 combined with the hard stop of the rigid bumper 410 to structurally handle higher force loads and also provide an improved and comfortable response.

Any of the features, components, and/or parts, including the arrangements and configurations thereof shown in FIGS. 4A through 4C can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 4A through 4C. The following description discusses force-deflection curves that graphically depict how example implementations of a facial interface and a rigid bumper react to an applied force.

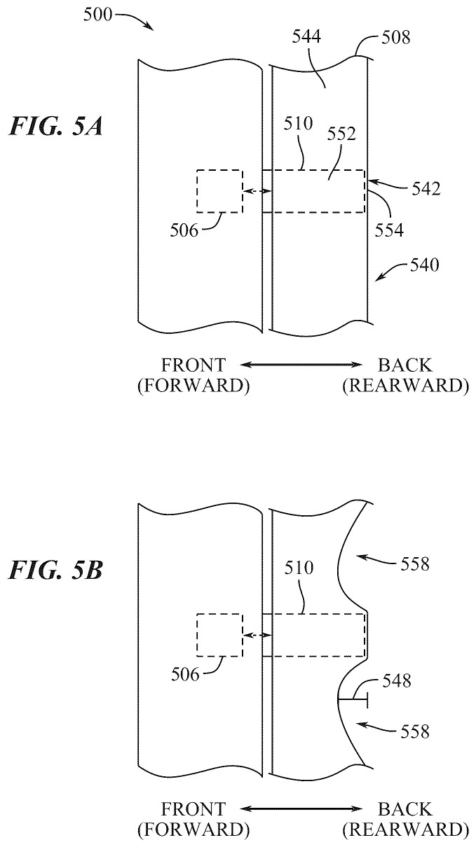

The following description discusses the interplay between a rigid bumper and a facial interface where an embedded portion of the rigid bumper can be positioned proximate to the skin-facing surface, or rear surface, of the facial interface. FIGS. 5A-5B illustrate yet another example implementation a rigid bumper in accordance with one or more examples of the present disclosure. In at least one example, the embedded portion 552 of the rigid bumper 510 can be positioned approximately flush with the rear surface 540 of the facial interface 508. In this example, the rigid bumper 510 can extend almost the entire length of the facial interface 508. In some examples, this can decrease the overall compressibility of the facial interface 508, which in turn can enable the rigid bumper 510 to more quickly bottom out when an applied force is exerted on the head-mountable device 500.

In at least one example, the end surface 542 of the rigid bumper 510 can include a cover flap 554. According to the present disclosure, the cover flap 554 can be constructed with a variety of materials. In some examples, the cover flap 554 can be constructed with a foam flap, a textile flap, or other kind of flap to prevent or reduce direct contact between a user's skin and the rigid bumper 510. In some examples, the cover flap 554 is constructed from a flexible material, a cushioned material, etc. In particular implementations, the cover flap 554 is a thin layer of the facial interface 508. In examples where the rigid bumper 510 can be positioned approximately flush with the rear surface 540 of the facial interface 508, the cover flap 554 can be advantageous in that it can be positioned between a user's skin and the rigid bumper 510. This can provide a more comfortable operating experience for the user in that the user can make direct contact with the cover flap 554 rather than the rigid bumper 510 (e.g., to avoid noticeably disparate surface temperatures in contact with the user skin).

In some examples, the rigid bumper 510 can include a set of rigid bumpers 510, each of which can be positioned approximately flush with the rear surface 540 of the facial interface 508. Furthermore, each end surface 542 of the rigid bumpers 510 in the set of rigid bumpers 510 can include a cover flap 554.

In at least one example of the present disclosure, the length of the rigid bumper 510 can be a set length, or a different length entirely. In some examples, the length of the rigid bumper 510 can extend partially through the facial interface 508. In other examples, the rigid bumper 510 can extend approximately the whole length of the facial interface 508. This can be advantageous to the head-mountable device 500 in that users can have heads of varying sizes. Different lengths of rigid bumpers 510 can be comfortable for some users and not for others. Varying lengths of rigid bumpers can provide a comfortable operating experience for a wide range of users.

FIG. 5B illustrates the components and relative positions shown in FIG. 5A with an applied force that is exerted to the head-mountable device 500. In at least one example, the rigid bumper 510 can be positioned approximately flush with the rear surface 540 of the facial interface 508. In this example, the travel length 548 can be dramatically shortened, wherein there is little compression between the rear surface 540 and the end surface 542 of the rigid bumper 510.

In at least one example, the facial interface 508 can compress in local compression zones 558, wherein the local compression zones 558 are not occupied by the embedded portion 552 of the rigid bumper 510. This can enable the head-mountable device 500 to exert a normal force opposite an applied force by use of the rigid bumper 510 while simultaneously absorbing more of the applied force through local compression zones 558. This can be advantageous to the user in that the head-mountable device 500 can immediately exert a normal force when an applied force is exerted on the head-mountable device 500 while also utilizing compression from the facial interface 508 in local compression zones 558. This can enable an increase in structural integrity to the overall device 500 while also preserving user comfort.

Any of the features, components, and/or parts, including the arrangements and configurations thereof shown in FIGS. 5A and 5B can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 5A and 5B.

The following description discusses the interplay between a rigid bumper and an energy dissipation layer. FIG. 6 shows yet another example implementation of a rigid bumper together with an energy dissipation layer according to one or more examples of the present disclosure. In one example, an energy dissipation layer 660 can be positioned between the display frame 604 and the facial interface 608. As used herein the term “energy dissipation layer” refers to a region of the head-mountable device 600 that can be a type of energy management layer designed to further absorb and/or dissipate energy of an applied force. In at least one example, the energy dissipation layer 660 can be designed to dissipate energy after the first force range 226 is utilized, as seen in FIG. 2B. For example, the energy dissipation layer 660 can be designed to absorb and/or dissipate forces ranging from about 5N to about 1000N, about 10N to about 750N, or about 100N to about 500N.

In some examples, the energy dissipation layer 660 can include different structures and materials. In some examples, this energy dissipation layer 660 can include a crush zone, a crumple region, a lattice region, a gel region, or any other region that can further distribute an applied force. Furthermore, in some examples, the energy dissipation layer 660 can be constructed from a material that is the same as the facial interface 608 or a different material entirely. In some examples, the energy dissipation layer 660 can be constructed out of a rigid material such as fiber-reinforced plastics, or more pliable materials, such as a foam or textile.

In this example, the energy dissipation layer 660 can be positioned forward of the front surface 638 of the facial interface 608 and behind the rear side 656 of the display frame 604. Furthermore, a portion of each rigid bumper 610 can be embedded in the energy dissipation layer 660.

In at least one example, the energy dissipation layer 660 can be configured to dissipate energy of an applied force after the cushion layer 644 of the facial interface 608 has been entirely compressed. The addition of the energy dissipation layer 660 can provide a third force range 232 to the head-mountable device 600, wherein the third force range 232 can be reached before a normal force is exerted from the rigid bumper 610. This can be advantageous in that a greater force can be applied before the rigid bumper 610 exerts a normal force in opposition to an applied force. This can increase the comfort felt by the user in that an applied force exerted on the head-mountable device 600 can be distributed over a greater area and a greater number of integrated components.

Any of the features, components, and/or parts, including the arrangements and configurations thereof shown in FIG. 6 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 6.

To the extent applicable to the present technology, gathering and use of data available from various sources can be used to improve the delivery to users of invitational content or any other content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, TWITTER® ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not intended to be exhaustive or to limit the embodiments to the precise forms disclosed. It will be apparent to one of ordinary skill in the art that many modifications and variations are possible in view of the above teachings.

What is claimed is:

1. A head-mountable device, comprising:
a display frame;
an optical component disposed within the display frame;
a facial interface; and
a rigid bumper connected to the display frame and positioned between the display frame and the facial interface, the rigid bumper defining a gap between the optical component and the facial interface.

2. The head-mountable device of claim 1, wherein the facial interface comprises a compressible portion.

3. The head-mountable device of claim 2, wherein the compressible portion is compressible until engagement with the rigid bumper.

4. The head-mountable device of claim 1, wherein the rigid bumper comprises a force-rating in excess of 20 Newtons.

5. The head-mountable device of claim 4, wherein the force-rating exceeds 1000 Newtons.

6. The head-mountable device of claim 1, wherein the rigid bumper comprises an aluminum material, a fiber-reinforced plastic material, or an engineering plastic material.

7. The head-mountable device of claim 1, wherein the rigid bumper is positionally fixed relative to the display frame and the facial interface.

8. The head-mountable device of claim 1, wherein the rigid bumper comprises a portion embedded within the facial interface.

9. The head-mountable device of claim 8, wherein the portion embedded within the facial interface is obscured from an exterior view of the facial interface.

10. The head-mountable device of claim 1, wherein:
the facial interface comprises a front surface opposite a rear, skin-facing surface; and
the rigid bumper comprises an end surface attached to the front surface.

11. A wearable apparatus, comprising:
a head-mountable display;
a facial interface having a cushion layer with a front surface facing the head-mountable display, the cushion layer being rated for applied loads within a first force range; and
a stop connected to the head-mountable display and the front surface, the stop being rated for applied loads within a second force range that is higher than the first force range.

12. The wearable apparatus of claim 11, the stop comprising an end surface connected to the front surface, a full length of the stop positioned in series with the facial interface.

13. The wearable apparatus of claim 11, wherein:
the cushion layer comprises an amount of travel configured to bottom out against the stop at an end of the first force range; and
at the end of the first force range, the stop is configured to provide a normal force against an applied load.

14. The wearable apparatus of claim 11, wherein the stop is removable from the front surface.

15. A wearable electronic device, comprising:
a display;
a facial interface having a front surface facing the display and a rear surface to contact a face when the wearable electronic device is donned; and
a first structural post attached to the head-mountable display adjacent to a forehead region of the face when donned; and
a second structural post attached to the head-mountable display adjacent to a maxilla region of the face when donned;
wherein a portion of each of the first structural post and the second structural post is embedded in the facial interface.

16. The wearable electronic device of claim 15, further comprising an energy dissipation layer positioned forward of the front surface of the facial interface, wherein a portion of each of the first structural post and the second structural post is embedded in the energy dissipation layer.

17. The wearable electronic device of claim 15, wherein an end portion of each of the first structural post and the second structural post is positioned forward of the rear surface.

18. The wearable electronic device of claim 15, wherein an end portion of each of the first structural post and the second structural post is positioned approximately flush with the rear surface.

19. The wearable electronic device of claim 18, wherein an end portion of the first structural post comprises a cover flap.

20. The wearable electronic device of claim 19, wherein the cover flap comprises a foam flap or a textile flap.
